(19) United States
(12) Patent Application Publication
(10) Pub. No.: US 2015/0266201 A1
(43) Pub. Date: Sep. 24, 2015

(54) PORTABLE CUTTING DEVICES

(71) Applicant: MAKITA CORPORATION, Anjo-shi (JP)

(72) Inventor: Tatsuo NAKASHIMA, Anjo-shi (JP)

(21) Appl. No.: 14/657,470

(22) Filed: Mar. 13, 2015

(30) Foreign Application Priority Data
Mar. 19, 2014 (JP) 2014-056533

(51) Int. Cl. B27B 9/00; B23Q 9/00; B25F 5/02

(52) U.S. Cl. CPC B27B 9/00; B25F 5/02; B23Q 9/00

(57) ABSTRACT

A portable cutting device may include a device body, a base and a hook. The device body may include a rotary cutter, a motor, a reduction mechanism coupled to the motor for rotating the rotary cutter, an accommodation portion for accommodating the reduction mechanism, and a fixed cover for covering the rotary cutter. The reduction mechanism may include an output shaft. The fixed cover may include a wall portion extending in a direction that is not parallel to the axial direction of the output shaft. The base may have an upper surface and a lower surface and may support the device body on an upper side of the upper surface. The hook may be attached to the wall portion of the fixed cover.

### CROSS-REFERENCE TO RELATED APPLICATIONS

This application claims priority to Japanese patent application serial number 2014-056533, the contents of which are incorporated herein by reference.

### BACKGROUND

Embodiments of the present disclosure relate to portable cutting devices having a device body and a base supporting the device body.

Portable cutting devices having a device body and a base supporting the device body are known. For example, Japanese Laid-Open Patent Publication No. 2006-326753 discloses a portable circular saw 100 as shown in FIG. 20. The portable circular saw 100 may include a saw body 102 as a device body having a centrally disposed tubular housing 104 for accommodating a reduction mechanism (not shown). A motor housing 105 may be formed in series with the tubular housing 104 on one side in the axial direction of the motor housing 105. A U-shaped hook 107 having a pair of arms may be mounted to the motor housing 105. More specifically, one of the pair of arms of the hook 107 may be supported by the outer side surface of the motor housing 105 such that it extends along an axis substantially parallel to the axial direction of the motor housing 105 and is rotatable about the axis.

Therefore, by hooking the hook 107 over a support structure, the portable circular saw 100 may be suspended from the support structure.

There has been a need in the art for a portable cutting device having a hook that is improved in usability.

### SUMMARY

In one aspect according to the present disclosure, a portable cutting device may include a device body, a base and a hook. The device body may include a rotary cutter, a motor and a reduction mechanism coupled to the motor and configured to rotate the rotary cutter, an accommodation portion configured to accommodate the reduction mechanism, and a fixed cover configured to cover the rotary cutter. The reduction mechanism may include an output shaft extending in a first direction. The fixed cover may include a wall portion extending in a second direction that is not parallel to the first direction. The base may have an upper surface and a lower surface and configured to support the device body on an upper side of the upper surface. The lower surface may contact a surface of a workpiece to be cut. The hook may be attached to the wall portion of the fixed cover.

With this arrangement, the hook may be positioned nearer to the gravity center of the portable cutting device. Therefore, the portable cutting device can be supported in stable when the portable cutting device is suspended from a support structure by hooking the hook over the support structure. In this respect, the hook is improved in usability

The hook may have a hook body including a first side portion, a second side portion opposite to the first side portion, and an intermediate portion connecting the first side portion ad the second side portion, so that the hook body has a substantially U-shape. The first side portion may be attached to the wall portion so as to extend substantially parallel to the wall portion.

With this arrangement, the weight of the portably cutting tool can be efficiently supported by the hook when the portable cutting device is suspended from the support structure via the hook.

The wall portion may be made of metal. Therefore, it is possible to increase the strength of the wall portion to which the hook is attached.

The wall portion of the fixed cover and the accommodation portion for the reduction mechanism may be formed integrally with each other.

The hook may be attached to the wall portion of the fixed cover at a position forwardly of a rotational axis of the rotary cutter with respect to a moving direction of the portable cutting device for cutting the workplace. With this arrangement, when the portable cutting device is suspended from the support structure via the hook, the front side of the portable cutting device may be oriented upward. Therefore, it may be possible to easily perform the operation for unhooking the hook from the support structure for carrying the circular saw to a work site, etc.

In the case that the hook body includes the first side portion, the second side portion and the intermediate portion, the first side portion of the hook body may be attached to the wall portion so as to be rotatable about an axis of the first side portion.

The first side portion of the hook body may extend in an axial direction along the wall portion of the fixed cover. The axial direction may be oriented upward and inclined rearward with respect to the moving direction of the portable cutting device. With this arrangement, it may be possible to minimize the protruding distance of the hook from the wall portion of the fixed cover.

The hook body may be pivotable between an operational position and a rest position about the axis of the first side portion. The device body may further include a handle and a grip portion disposed at the handle. As the hook body pivots from the operational position to the rest position, the hook body may pass over the handle, so that the hook body is not positioned above the grip portion when at the at the rest position.

The handle may include an accommodation recess configured to accommodate at least a part of the intermediate portion of the hook body when the hook body is positioned at the rest position.

The fixed cover may include an axially inner wall disposed on a side of the motor, an axially outer wall opposite to the axially inner wall, and a circumferential wall connecting the axially inner wall and the axially outer wall. The wall portion to which the hook is attached may be a part of the axially inner wall.

In another aspect according to the present disclosure, a portable cutting device may include a device body, a base and a hook attached to at least one of the device body and the base. The device body may include a rotary cutter, a motor configured to rotate the rotary cutter about a rotational axis, and a fixed cover configured to cover an upper part of the rotary cutter. The base may have an upper surface and a lower surface and configured to support the device body on an upper side of the upper surface. The lower surface may be configured to contact a surface of a workpiece to be cut. The hook may have a hook body attached to at least one of the device body and the base so as to be pivotable relative thereto between an operational position and a rest position about a pivotal axis extending in a direction that is not parallel to the rotational axis of the rotary cutter.

### BRIEF DESCRIPTION OF THE DRAWINGS

FIG. 1 is a perspective view of a portable circular saw according to a first embodiment;

FIG. 2 is a left side view of the portable circular saw;

FIG. 3 is a right side view of the portable circular saw;

FIG. 4 is a plan view of the portable circular saw;

FIG. 5 is a sectional view taken along line V-V in FIG. 4;

FIG. 6(A) is a plan view of a controller of the portable circular saw;

FIG. 6(B) is a perspective view of the controller:

FIG. 7 is a sectional view taken along line VII-VII in FIG. 3;

FIG. 8 is a perspective view of a base of the portable circular saw and various components associated with the base;

FIG. 9 is a sectional view taken along line IX-IX in FIG. 4;

FIG. 10 is a sectional view taken along line X-X in FIG. 4:

FIG. 11 is a front view of the portable circular saw showing a saw unit positioned at a vertical position;

FIG. 12 is a front view of the portable circular saw showing the saw unit positioned at an inclined position;

FIG. 13 is a sectional view taken along line in FIG. 3;

FIG. 14 is a sectional view taken along line XIV-XIIV in FIG. 3;

FIG. 15 is a sectional view take along line XV-XV in FIG. 3;

FIG. 16 is a plan view of a portable circular saw according to a second embodiment;

FIG. 17 is a side view of the portable circular saw according to the second embodiment;

FIG. 18 is a plan view of a portable circular saw according to a third embodiment;

FIG. 19 is a side view of the portable circular saw according to the third embodiment; and

FIG. 20 is a perspective view of a known portable circular saw.

### DETAILED DESCRIPTION

### First Embodiment

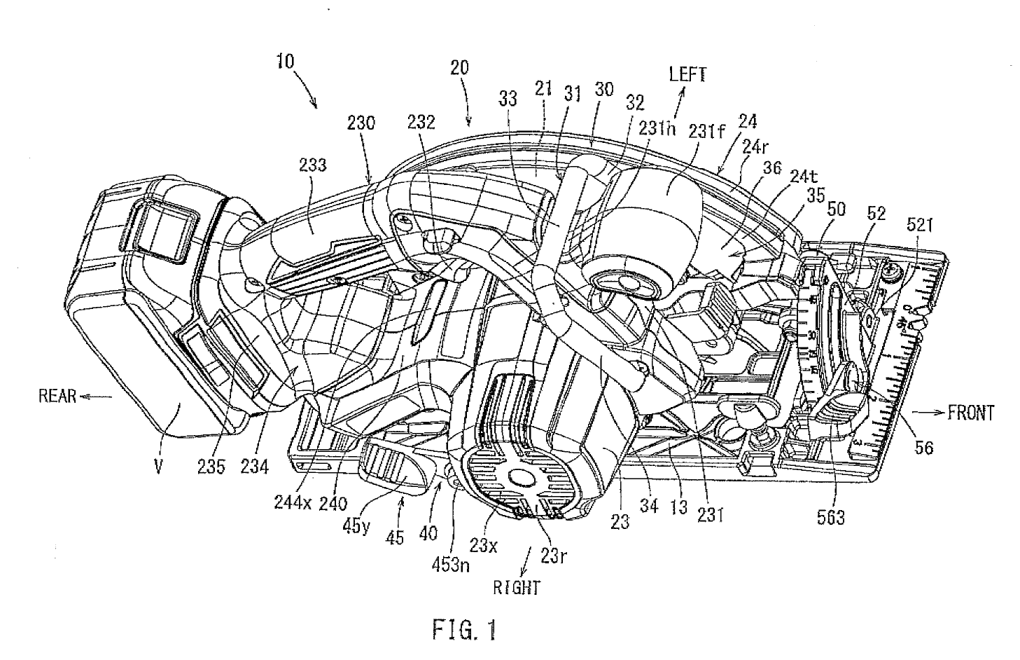

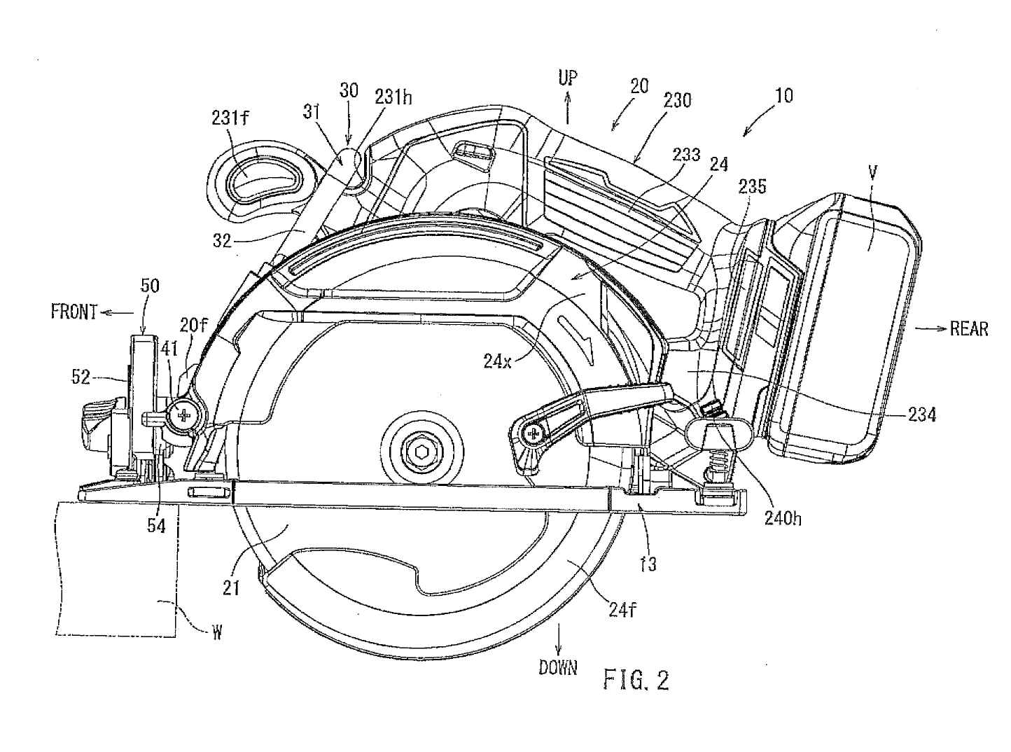

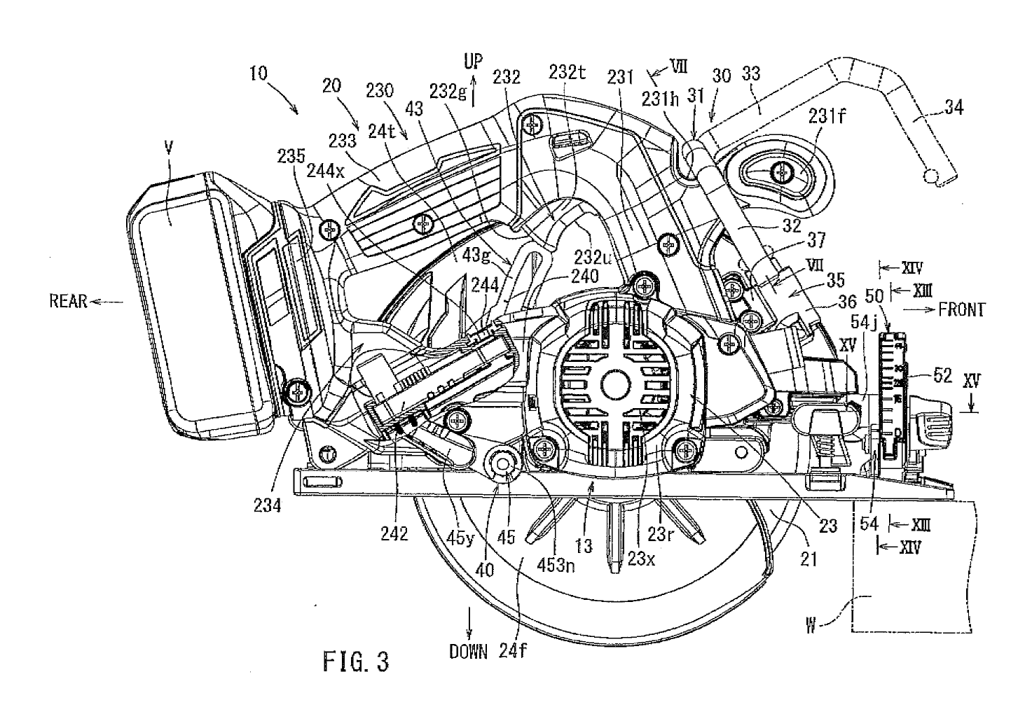

A first Embodiment will now be described with reference to FIGS. 1 to 15. Referring to FIGS. 1 to 4, there is shown a portable circular saw 10 according to a first embodiment. The portable circular saw 10 is an example of a portable cutting device. The portable circular saw 10 may be used for cutting a workpiece W (see FIGS. 2 and 3). For the purpose of explanation, a moving direction of the portable circular saw 10 for cutting the workpiece W will be determined as a forward direction. A rearward direction, a rightward direction, a leftward direction, an upward direction and a downward direction will be determined with reference to the forward direction.

### <General Construction of Portable Circular Saw>

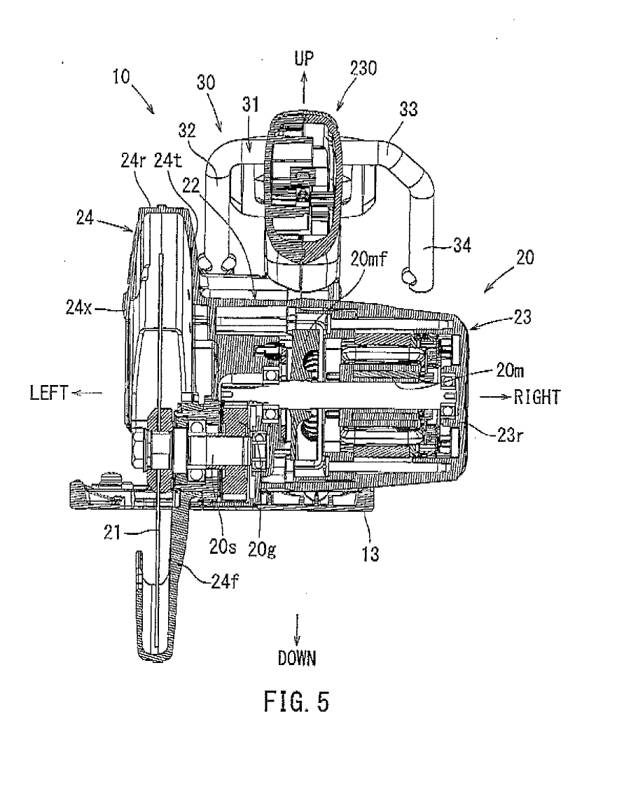

As shown in FIG. 5, the portable circular saw 10 may generally include a saw body 20 and a base 13. The saw body 20 may serve as a device body and may include a circular saw blade 21 serving as a rotary cutter, a motor 20m and a reduction mechanism 20g. The saw blade 21 may be rotatably driven by the motor 20m via the reduction mechanism 20g. The base 13 may have a substantially rectangular shape and may support the saw body 20 on its upper side. The lower surface of the base 13 may contact the upper surface of the workpiece W during the cutting operation. The portable circular saw 10 may further include a cutting depth adjustment mechanism 40 and an inclination angle adjustment mechanism 50. The cutting depth adjustment mechanism 40 may allow adjustment of a protruding distance of the saw blade 21 from the lower surface of the base 13, so that a cutting depth of the saw blade 21 into the workpiece W can be adjusted. The inclination angle adjustment mechanism 50 may allow adjustment of a position of the saw blade 21 relative to the upper surface of the base 13 between a vertical position and a variety of inclined positions. In the vertical position, the saw blade 21 may extend substantially vertically relative to the base 13. In the inclined positions, the saw blade 21 may be inclined laterally relative to the vertical position.

### <Saw Body>

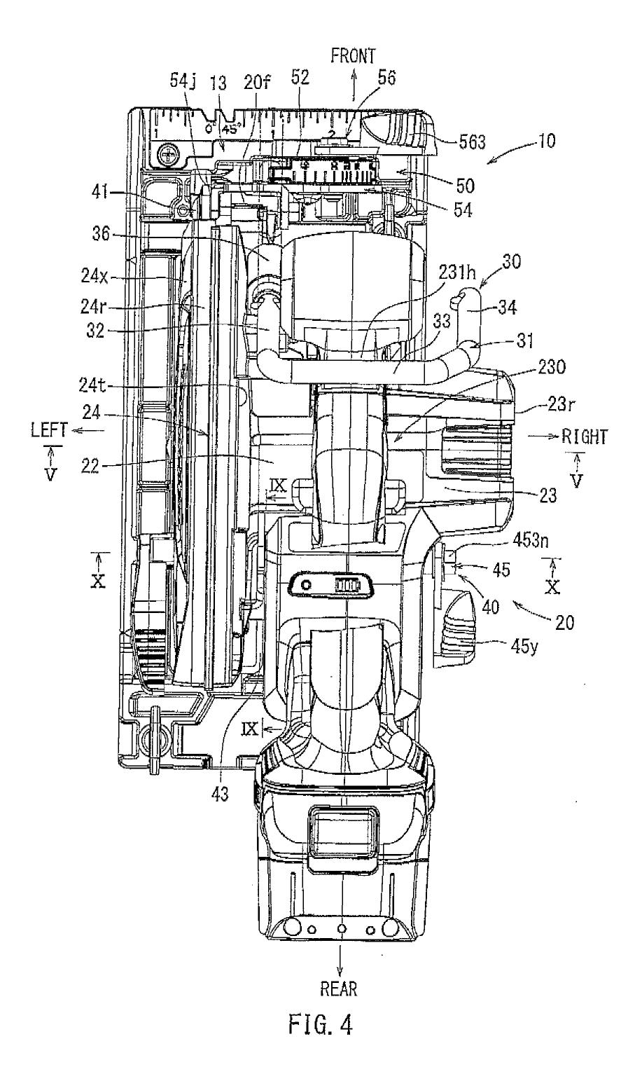

The motor 20m of the saw body 20 may be a DC brushless motor. Referring to FIG. 5, the rotation of the motor 20m may be transmitted to the saw blade 21 via the reduction mechanism 20g. As shown in FIGS. 4 and 5, the saw body 20 may include a housing portion 22 disposed substantially centrally of the saw body 20. The housing portion 22 may have a tubular shape and may be made of metal. The reduction mechanism 20g may be a reduction gear mechanism and may be disposed within the housing portion 22. Therefore, the housing portion 22 may be hereinafter also called a gear housing 22. A motor housing 23 may be made of resin and may be arranged in series with the right side portion of the gear housing 22. A spindle 20s sewing as an output shaft of the reduction mechanism 20g may protrude leftward from the gear housing 22. A circular saw blade 21 may be fixedly attached to the protruding end portion of the spindle 20s. A fixed cover 24 may cover a substantially upper half of the saw blade 21. The fixed cover 24 may include an axially inner vertical wall 24t, a radially outer circumferential wall 24r and an axially outer vertical wall 24x. The axially inner vertical wall 24t may have a substantially semicircular shape and may extend radially outward from the left end of the gear housing 22 in a direction substantially parallel to the saw blade 21 in order to cover the left side surface (axially inner side surface) of the saw blade 21. The radially outer circumferential wall 24r extends along the radially outer side edge of the axially inner vertical wall 24t for covering the saw blade 21 from the radially outer side. The axially outer vertical wall 24x is connected to the left side edge of the radially outer circumferential wall 24r for covering the right side surface (axially outer side surface) of the saw blade 21. The fixed cover 24 and the gear housing 22 may be formed of metal and may be integrated with each other by molding together. As shown in FIG. 2, a safety cover 24f may be mounted to the fixed cover 24 so as to be movable between a closing position and an opening position for covering and uncovering a substantially lower half of the saw blade 21. More specifically, as the saw body 20 moves in a cutting direction for cutting the workpiece W, the safety cover 24 may move from the closing position to the opening position as it moves into the fixed cover 24f against a biasing force of a spring (not shown) through contact with the workpiece W.

As shown in FIG. 1, the motor housing 23 may be molded to have a shape of a bottomed tubular container. A plurality of air inlet holes 23x may be formed in a right end wall 23r of the motor housing 23 for introduction of external air into the motor housing 23. A loop-shaped handle 230 may be attached to the motor housing 23 and can be held by a hand of the user. As shown in FIGS. 1 through 4, the handle 230 may be disposed on the right side of the fixed cover 24 so as to extend substantially parallel to the fixed cover 24 as viewed from the upper side. As shown in FIG. 3, the handle 230 may include an upwardly extending portion 231 and a rear grip portion 233. The upwardly extending portion 231 may be fixedly attached to the front portion of the motor housing 23 and may extend upward therefrom in a direction obliquely rearward. The rear grip portion 233 may extend downwardly from the upper portion of the upwardly extending portion 231 in a direction obliquely rearward. The rear grip portion 233 may have a connecting portion 235 disposed at its rear end. A rechargeable battery V can be connected to and removed from the connecting portion 235 as it is slid in a vertical direction relative thereto. The handle 230 may further include a base portion 234 that is fixedly attached to the rear side surface of the motor housing 23 so as to extend rearward therefrom. The connecting portion 235 may be connected to the base portion 234. A front grip portion 231f may be disposed at the upwardly extending portion 231 of the handle 230 and may protrude forwardly from the front end surface of the upwardly extending portion 231.

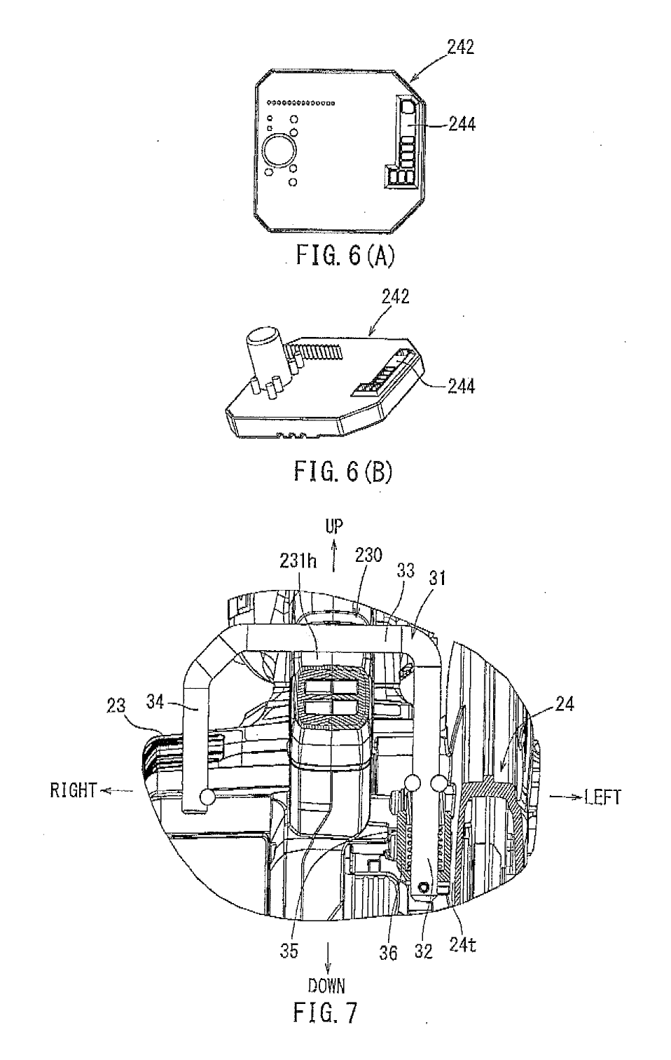

As shown in FIG. 3, a trigger switch 232 may be mounted to the lower side of the handle 230 at a position between the upwardly extending portion 231 and the rear grip portion 233, so that the trigger switch 232 can be operated as it is pulled by a finger(s) of a hand of the user who grasps the handle 230. More specifically, the trigger switch 232 may include a switch body (not shown) and a trigger 232t. The switch body may be fixedly mounted within the rear grip portion 233 of the handle 230. The trigger 232t may be vertically pivotally movable relative to the switch body and may protrude downwardly from the rear grip portion 233. A finger contact surface 232u having a concave shape for engagement with the finger(s) may be formed on the lower front part of the downwardly protruding portion of the trigger 232t. A guide surface 232g having a substantially arc shape may be formed on the rear side of the finger contact surface 232u. As shown in FIG. 1, the base portion 234 of the handle 230 may include a shield portion 240. The shield portion 240 may have a substantially rectangular flat box shape and may protrude in right and left directions from the base portion 234. The shield portion 240 may serve to inhibit cutting chips or powder produced during the cutting operation of the workpiece W, from rising upward toward the user. As shown in FIG. 3, a space may be formed in the shield portion 240 for accommodating a controller 242 that may control the motor 20m. In addition, a display portion 244x may be disposed at a central portion with respect to a widthwise direction of the upper surface of the shield portion 240. The display portion 244x may be used for displaying various information regarding the circular saw 10. In this embodiment, as shown in FIGS. 6(A) and 6(B), the controller 242 may have an indicator 244. The indicate 244 may be a remaining level indicator for indicating the remaining level of the battery V or a speed indicator for indicating the rotational speed of the motor 20m or the spindle 20s which may be automatically changed under the control of the controller 242. Therefore, in this embodiment, the display portion 244x is a view window through which the user can observe the indicator 244 of the controller 242.

### <Controller and Motor of Saw Body>

The controller 242 may include an electronic circuit board for driving the motor 20m with the supply of the electric power from the battery V. In this embodiment, the motor 20m is a DC brushless motor. As shown in FIGS. 6(A) and 6(B), the controller 242 may have a substantially rectangular flat plate shape. As shown in FIG. 3, the controller 242 may be accommodated within the shield portion 240 so as to extend substantially parallel to the extending direction of the shield portion 240. For example, the controller 242 may include a three-phase bridge circuit and a microcomputer (not shown). The three-phase bridge circuit may include six switching elements (not shown). The microcomputer may control the three-phase bridge circuit according to signals outputted from the trigger switch 232, etc. For example, the microcomputer may turn on/off the switching elements in a predetermined order, so that a rotating magnetic field may be generated in each of U-phase, V-phase and W-phase drive coils of a stator of the motor 20m to cause rotation of a rotor of the motor 20m in a direction of the rotating magnetic field. Further, the microcomputer may monitor the remaining level of the battery V and may output a corresponding signal to the indicator 244 disposed at the front portion of the upper surface of the controller 242.

By using a DC brushless motor as the motor 20m, no brush and no commutator are necessary. Therefore, it may be possible to reduce the length of the motor 20m in the axial direction in comparison with the case where a brushed DC motor is used. Hence, the length in the axial direction of the motor housing 23 can be reduced, and eventually, it is possible to reduce the distance between the handle 230 and the fixed cover 24.

### <Flow of Cooling Air in Saw Body>

As shown in FIG. 5, a fan 20mf may be mounted to a rotational shaft of the motor 20m and may rotate about the same axis as the rotational shaft. As the motor 20m is driven, the fan 20mf may rotate to produce a flow of external air into the motor housing 23 via the air inlet holes 23x formed in the right end wall 23r. The external air flown into the motor housing 23 may cool the motor 23m and may then be introduced into the shield portion 240 disposed at the base portion 234 of the handle 230 through the rear wall of the motor housing 23. After cooling the switching elements, etc. of the controller 242 accommodated within the shield portion 240, the flow of the external air may be divided into first, second and third different streams. The first stream may be oriented to the outside via an air outlet hole 240h (see FIG. 2) formed in the rear end portion of the shield portion 240. The second stream may be oriented forwardly toward the front side of the fixed cover 24 to provide a function as a blower. The third stream may be oriented to the outside via a blow window (not shown) that may be formed in the front portion of the motor housing 23 and oriented obliquely downward.

### <Hook of Saw Body>

As shown in FIGS. 1 through 4, the saw body 20 may be provided with a hook 30. By hooking the hook 30 over a support structure (not shown), the portable circular saw 10 may be suspended from the support structure.

As shown in FIG. 1, etc., the hook 30 may include a hook body 31 having a substantially U-shape. More specifically the hook body 31 may include a first side portion 32, an intermediate portion 33 and a second side portion 34 each having a shape like a rod. The first side portion 32 and the second side portion 34 may extend substantially parallel to each other. The intermediate portion 33 may have opposite ends respectively connected to the upper end of the first side portion 32 and the upper end of the second side portion 34. As shown in FIG. 3, the first side portion 32 may be attached to the axially inner vertical wall 24t of the fixed cover 24 via a bracket 35. The bracket 35 may include a support tube 36 and a flange 37. The first side portion 32 may be connected to the support tube 36, while the flange 37 may be fixedly attached to the axially inner vertical wall 24t via screws. More specifically, as shown in FIG. 7, the first side portion 32 may be inserted into the support tube 36. In this state, the first side portion 32 can rotate relative to the support tube 36 about its axis. The flange 37 of the bracket 35 may be fixed to the axially inner vertical wall 24t in a state that the first side portion 32 of the hook body 31 extends along the outer surface of the axially inner vertical wall 24t of the fixed cover 24. More specifically, in this state, the first side portion 32 may extend upward from the outer surface of the axially inner vertical wall 24t (i.e., the front end surface of the fixed cover 24) so as to be inclined obliquely rearward.

In the mounted state of the hook 30 to the axially inner vertical wall 24t of the fixed cover 24 via the bracket 35, the first side portion 32 of the hook body 31 and the support tube 36 of the bracket 35 may extend within a plane that is substantially parallel to the axially inner vertical wall 24t. When the hook 30 is to be used, the hook body 31 may be pivoted leftward from a position indicated by solid lines (hereinafter called a “rest position”) by an angle of about 90 degrees about the axis of the first side portion 32 until the intermediate portion 33 is positioned substantially parallel to the axially inner vertical wall 24t as indicated by chain lines in FIG. 3. Therefore, the second side portion 34 of the hook body 31 may be positioned on the front side of the handle 230. With the second side portion 34 positioned in this way, the second side portion 34 can be hooked to the support structure. For, example the support structure may include a horizontal beam for hooking by the hook 30. The position of the hook body 31 when the intermediate portion 33 is positioned as indicated by chain lines will be hereinafter called an “operational position.” When the circular saw 10 is used for the cutting operation, the hook body 31 may be pivoted rightward by an angle of about 90 degrees from the operational position to the rest position, so that the intermediate portion 33 of the hook body 31 may move to pass over the front grip portion 231f and to reach a position above a boundary region between the front grip portion 231f and the upwardly extending portion 231. An accommodation recess 231h may be formed in the boundary region for accommodating a central portion with respect to the axial direction of the intermediate portion 33 when the hook body 31 is positioned at the rest position. Therefore, the user can easily grasp the front grip portion 231f and the rear grip portion 233 without being interfered by the hook body 31. In the rest position, the intermediate portion 33 is positioned upward of the first and the second side portions 31 and 32. In other words, the intermediate portion 33 serves as an upper portion of the hook body 31.

### <Base of Circular Saw>

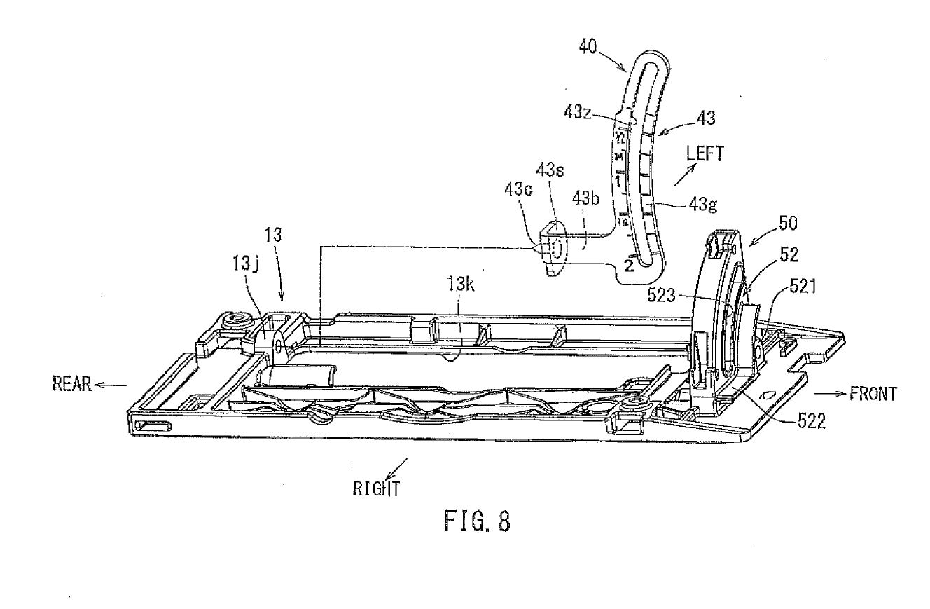

As shown in FIG. 1, etc., the base 13 may be a rectangular plate having an upper surface and a lower surface. The saw body 20 may be supported on the upper surface of the base 13. The lower surface may contact the upper surface of the workpiece W during the cutting operation. As shown in FIG. 8, the base 13 my include an opening 13k elongated in front and rear directions, so that the saw blade 21 and the safety cover 24t can protrude downward from the lower surface of the base 13 via the opening 13k. An angular plate 52 may be disposed at a front end of the upper surface of the base 13. The angular plate 52 is one of components of an inclination angle adjusting mechanism 50 that will be explained later. The angular plate 52 may have a sectorial shape and may be mounted to the upper surface of the base 13 such that it extends vertically from the upper surface of the base 13, while the opposite surfaces of the angular plate 42 extend substantially parallel to the front edge of the base 13. As shown in FIG. 8, a base portion of the angular plate 52 corresponding to a center of the arc of the sectorial shape may be located on the left side with respect to the base 13. A front bearing 521 may be mounted to the base 13 at a position on the left side of the angular plate 52 and may be arranged along a line extending leftward from the base portion of the angular plate 52. The front bearing 521 may provide a pivotal axis about which the saw body 20 pivots in left and right directions. To this end, the front bearing 521 may have a bearing hole having an axis extending in the front and rear directions.

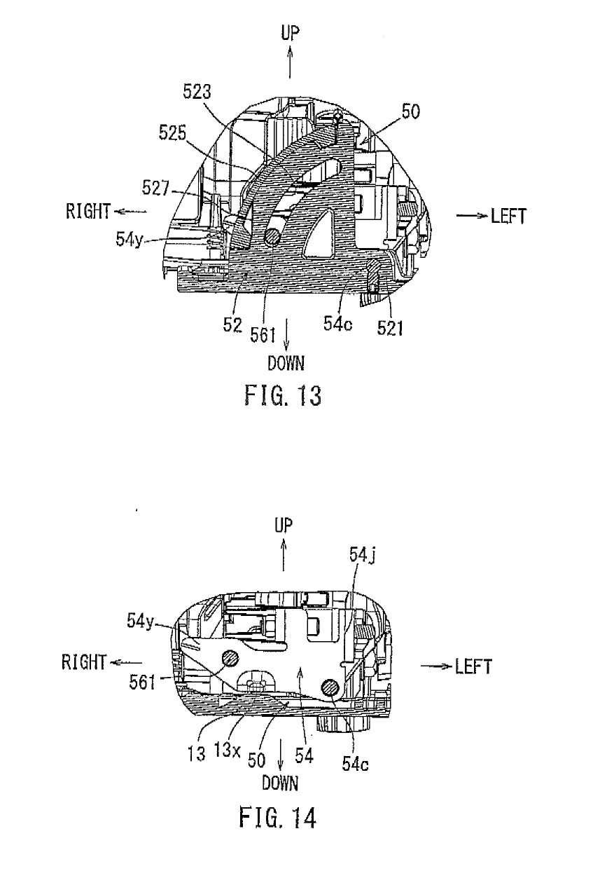

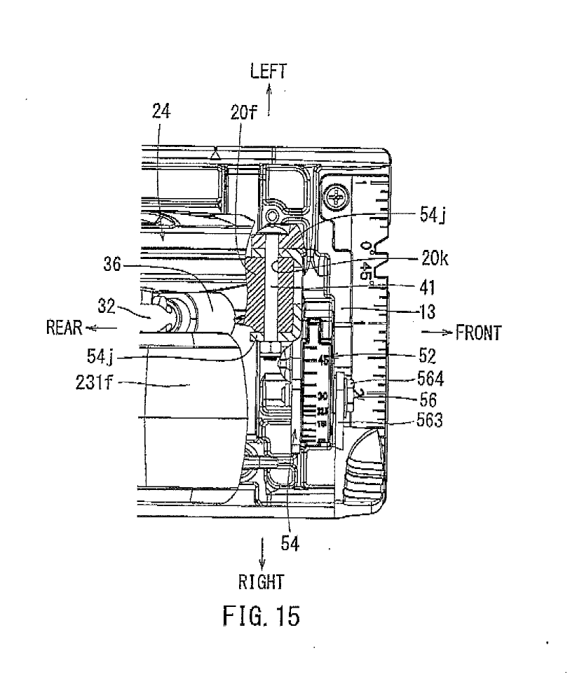

As shown in FIG. 3 and FIGS. 13 though 16, an angular guide 54 may disposed on the rear side of the angular plate 52 so as to be arranged side-by-side therewith in the front and rear directions. The angular guide 53 may serves as one of components of the inclination angle adjusting mechanism 50 and may also serve as one of components of the cutting depth adjusting mechanism 40. As shown in FIGS. 13 and 14, the angular guide 54 has a shaft 54c. The shaft 54 may be disposed at the left lower corner portion of the angular guide 54 and may be inserted into the bearing hole of the front bearing 521 so as to be rotatably supported by the front bearing 521. Therefore, the angular guide 54 can pivot in left and right directions along the angular plate 52. As shown in FIG. 15, a bearing portion 54j having a substantially U-shape in plan view may be formed on the upper portion of the angular guide 54 for rotatably supporting a connection bolt 41. The connection bolt 41 may be inserted into a front end portion 20f of the saw body 20 so as to extend in the right and left directions. In this way, the front end portion 20f of the saw body 20 may be vertically pivotally connected to the bearing portion 54j of the angular guide 54.

As shown in FIG. 8, a rear bearing 13j may be disposed at the rear portion of the base 13 on the rear side of the opening 13k. The rear bearing 13j may have a bearing hole extending in the front and rear directions. The rear bearing 13j may serve to support a depth guide 43 that is connected to the rear portion of the saw body 20 such that the depth guide 43 can pivot in right and left directions relative to the base 13. More specifically, the depth guide 43 may have a pivotal shaft 43c. The pivotal shaft 43c may protrude rearward from the lower portion of the depth guide 43 and may be rotatably supported by the bearing hole of the rear bearing 13j. Therefore, the depth guide 43 can pivot in right and left directions about the axis of the pivotal shaft 43c.

In this way, the saw body 20 may be supported by the base 13 such that the saw body 20 can pivot vertically about the axis of the connection bolt 41 disposed at the front end 20f and can pivot in right and left directions via the angular guide 54 and the depth guide 43.

### <Cutting Depth Adjustment Mechanism>

The cutting depth adjustment mechanism 40 may be used for adjusting the protruding distance of the saw blade 21 from the lower surface of the base 13 through adjustment of the vertical pivotal angle of the saw body 20 about the axis of the connection bolt 41 disposed at the front end 20f. The cutting depth adjustment mechanism 40 may include the angular guide 54 having the bearing portion 54j for vertically pivotally supporting the front end 20f of the saw body 20, the depth guide 43 for guiding the rear portion of the saw body 20 during the vertical pivotal movement, and a guide lock mechanism 45 (see FIGS. 4 and 10) that can look and unlock the position of the saw body 20 relative to the depth guide 43.

As shown in FIG. 15, the front end 20f of the saw body 20 may extend forwardly from the fixed cover 24 and may be molded integrally with the fixed cover 24. A through-hole 20k may be formed in the front end 20f to extend therethrough in the right and left directions. When the front end 20f is fitted into the bearing portion 54j having the U-shape of the angular guide 54, the through-hole 20k may be aligned with bearing holes formed in the bearing portion 54j. In this state, the connection bolt 41 may be inserted into the through-hole 20k and the bearing holes. In this way, the saw body 20 can be vertically pivotally connected to the angular guide 54.

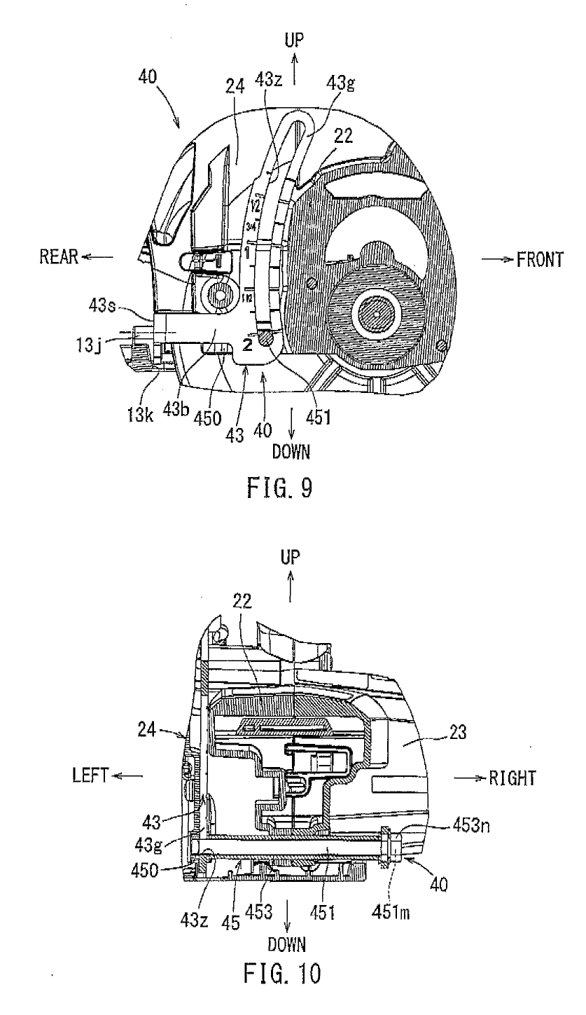

As shown in FIGS. 8 and 9, the depth guide 43 may include a guide plate portion 43g, a rear straight plate portion 43b and a fixing plate portion 43s. The guide plate portion 43g may have a shape curved along an arc for guiding the vertical movement of the rear portion of the saw body 20. The rear straight plate portion 43b may extend rearward from the lower portion of the guide plate portion 43g. The fixing plate portion 43s may extend from the rear end of the straight plate portion 43b and may be bent leftward at a right angle therefrom. The pivotal shaft 43c may extend rearward from the fixing plate portion 43s. The guide plate portion 43g of the depth guide 43 may be formed to extend along an arc that may conform to a moving path of the rear portion of the saw body 20 during the vertical pivotal movement of the saw body 20 about the axis of the connection bolt 41. A guide slot 43z may be formed in the guide plate portion 43g at the central portion with respect to the width of the guide plate portion 43g and may extend along the are thereof. The lower end of the guide slot 43z may be positioned at a level that is lower than the lower edge of the straight plate portion 43b and is also lower than the axis of the pivotal shaft 43c.

As described previously, the depth guide 43 may be mounted to the base 13 so as to be pivotable in right and left directions relative to the base 13 through connection of the pivotal shaft 43c to the rear bearing 13j. In this mounted state, as shown in FIGS. 3 and 4, the depth guide 43 may extend along the surface of the gear housing 22 at a position between the handle 230 and the fixed cover 24. Therefore, when the user grasps the rear grip portion 233 of the handle 230 by his dominant hand (right hand in this embodiment) and pulls the trigger switch 232 by the finger(s), the guide plate portion 43g of the depth guide 43 may be located such that the finger(s) of the user is oriented toward the guide plate portion 43g.

As shown in FIGS. 9 and 10, the guide leek mechanism 45 may include a horizontal rod 451. The horizontal rod 451 may be disposed at the rear portion of the saw body 20 and may be inserted into the guide slot 43z of the depth guide 43 in a direction perpendicular to the surfaces of the guide plate portion 43g. The guide lock mechanism 45 may further include a holder 450 formed on the fixed cover 24 of the saw body 20 for holding the guide plate portion 43g of the depth guide 43 from the left side. As shown in FIG. 10, the left end of the horizontal rod 451 may have a head portion that can be held by the holder 450. The guide lock mechanism 45 may further include a cylindrical tube 453 that may serve to hold the guide plate portion 43g of the depth guide 43 from the side opposite to the holder 450 of the fixed cover 24. The horizontal rod 451 may be inserted into the cylindrical tube 453 after insertion into the guide slot 43z of the guide plate portion 43g. A male thread 451 may be formed on the right end of the horizontal rod 451. A nut 453n may engage the male thread 451 and may oppose to the right end of the cylindrical tube 453. As shown in FIGS. 1, 3 and 4, an operation lever 45y may be fixedly attached to the nut 453n.

As the nut 453n rotates in a tightening direction by the operation of the operation lever 45y, the horizontal rod 451 may move rightward through engagement of the nut 453n with the male thread 451, so that the guide plate portion 43g of the depth guide 43 may be clamped between the holder 450 and the left end of the cylindrical tube 453. In this way, the rear portion of the saw body 20 can be fixed in position relative to the depth guide 43. In other words, the rear portion of the saw body 20 can be locked against the depth guide 43. On the other hand, as the nut 453n rotates in a loosening direction opposite to the tightening direction by the operation of the operation lever 45y, the lock state of the rear portion of the saw body 20 against the depth guide 43 can be released. In other words, the rear portion of the saw body 20 can be unlocked. In this state, the horizontal rod 451 is allowed for moving vertically along the guide slot 43z formed in the guide plate portion 43g, and therefore, the saw body 20 can pivot vertically about the axis of the connection bolt 41.

In this way, the saw body 20 can pivot downward to a lowermost position shown in FIG. 9 where the horizontal rod 451 is positioned at the lowermost end of the guide slot 43z of the guide plate portion 43g of the depth guide 43. When the saw body 20 is positioned at the lowermost position, the saw blade 21 may protrude from the lower surface of the base 13 by a maximum distance that provides a maximum cutting depth. On the other hand, when the saw body 20 pivots upward to an uppermost position where the horizontal rod 451 is positioned at the uppermost end of the guide slot 43z, the saw blade 21 may protrude from the lower surface of the base 13 by a minimum distance that provides a minimum cutting depth. A scale indicating the cutting depth may be marked on the guide plate portion 43g of the depth guide 43 along the guide slot 43z.

When the saw body 20 is positioned at the lowermost position shown in FIG. 9 where the horizontal rod 451 is positioned at the lowermost end of the guide slot 43z of the guide plate portion 43g of the depth guide 43, a protruding distance of the upper end of the guide plate portion 43g of the depth guide 43 above the saw body 20 may become maximum. In addition, the saw body 20 may be positioned at the nearest position to the upper end of the guide plate portion 43g with respect to the front and rear directions (see FIG. 3). However, as described previously, the lower end of the guide slot 43 of the guide plate portion 43g of the depth guide 43 may be positioned lower than the lower edge of the straight plate portion 43b and also lower than the axis of the pivotal shaft 43c. Therefore, it may be possible to set the upper end position of the guide slot 43 at a lower position to minimize the protruding distance of the upper end of the guide plate portion 43g. It may be also possible to position the upper end of the guide plate portion 43g on the rear side of the finger engaging surface 232u of the trigger switch 232 mounted to the handle 230. More specifically, the upper end of the guide plate portion 43g may be positioned on the rear side of a point where a line extended from the finger engaging surface 232u and a line extended from the guide surface 232g of the trigger switch 232 intersect with each other. Therefore, even though the guide plate portion 43g of the depth guide 43 may be positioned near the handle 230 as shown in FIG. 3, the finger(s) of the user operating the trigger switch 232 may not contact the depth guide 43. In addition, in this embodiment, the upper end portion of the guide plate portion 43g of the depth guide 43 may not extend outward beyond the outer circumferential surface of the fixed cover 24.

### <Inclination Angle Adjustment Mechanism>

The inclination angle adjustment mechanism 50 may be used for adjusting the position of the saw blade 21 of the saw body 20 between a vertical position and a variety of inclined positions relative to the base 13. The inclination angle adjustment mechanism 50 may include the angular plate 52 and the angular guide 56 that support the front portion of the saw body 20 as described previously. The inclination angle adjustment mechanism 50 may further include an inclination lock mechanism 56 that may serve to releasably lock the angular guide 54 against the angular plate 52 as will be explained later. The depth guide 43 and the rear bearing 13j of the base 13, which support the rear portion of the saw body 20, may also serve as components of the inclination angle adjustment mechanism 50.

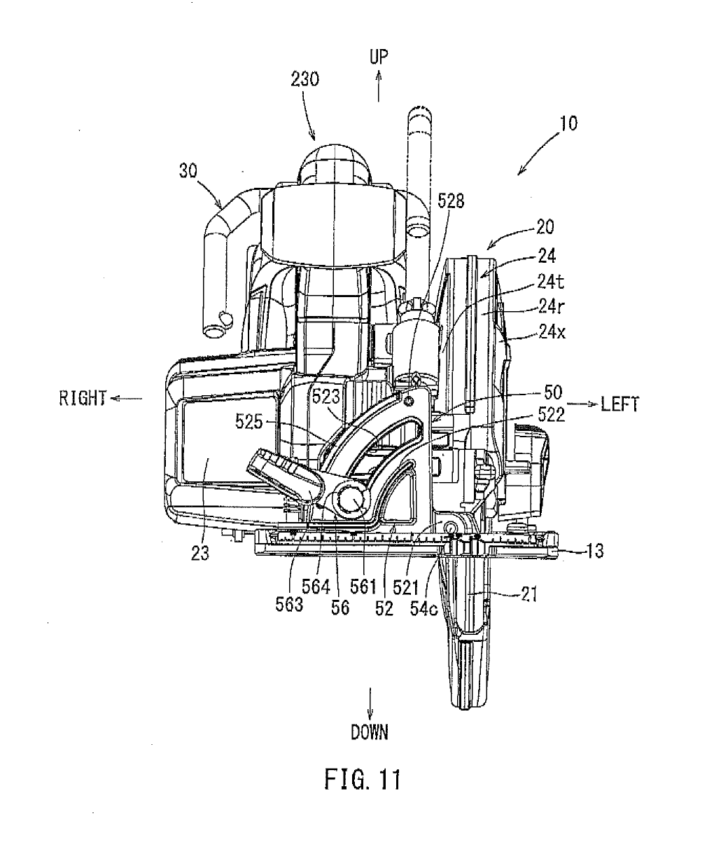

As shown in FIGS. 11 and 13, an arcuate guide slot 523 may be formed in the angular guide plate 52 along an arc that conforms to an arc about the bearing hole of the front bearing 521. The inclination lock mechanism 56 may include a horizontal rod 561. The horizontal rod 561 may be attached to a free end portion of the angular guide 54 and extend horizontally through the guide slot 523. A male thread may be formed on the front portion of the horizontal rod 561. As shown in FIG. 11, a nut 564 may be engaged with the male thread of the horizontal rod 561 and may be connected to an operation lever 563. When the operation lever 563 is pivoted leftward to a position where the operation lever 563 is oriented substantially vertically upward, the nut 564 may be tightened against the male thread of the horizontal rod 561, so that the angular plate 52 may be clamped between the operation lever 563 and the angular guide 54. In this way, the angular plate 52 may be prevented from pivoting relative to the angular guide 54. On the other hand, when the operation lever 563 is pivoted rightward from the lock position to a release position for releasing the tightening of the nut 564, the angular plate 52 may be permitted to pivot relative to the angular guide 54.

As shown in FIG. 14, an angle adjusting screw 13x may be engaged with the base 13 and may have a head portion vertically opposing to the lower surface of the free end portion of the angular guide 54. For example, the engaging position of the angle adjusting screw 13x with respect to the base 13 may be adjusted such that the saw blade 21 of the saw body 20 extends substantially vertically relative to the base 13 as shown in FIG. 11 when the lower surface of the free end portion of the angular guide 54 contacts the head portion of the angle adjusting screw 13x. When the lower surface of the free end portion of the angular guide 54 contacts the head portion of the angle adjusting screw 13x, the horizontal rod 561 of the angular guide 54 may be positioned proximal to the lower end of the guide slot 523 of the angular plate 52 as shown in FIG. 13. As the saw body 20 is pivoted leftward from the vertical position shown in FIG. 11, the horizontal rod 561 of the angular guide 54 may move upward along the guide slot 523 of the guide plate 52. In this way, the saw body 20 can be pivoted leftward until the horizontal rod 561 reaches the upper end of the guide slot 523 of the angular plate 52.

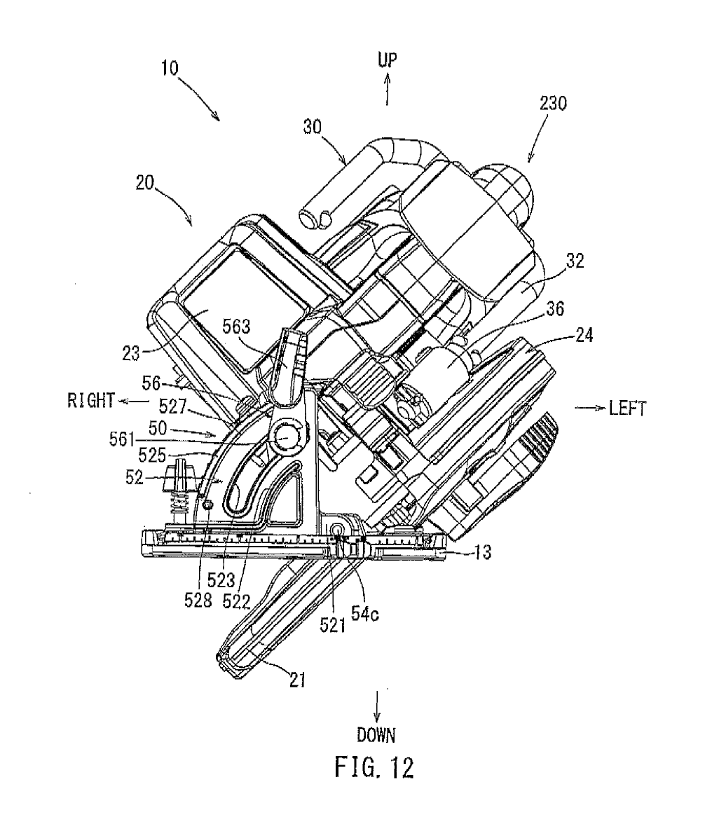

When the operation lever 563 is positioned at the release position for releasing the tightening of the nut 564, the operation lever 563 may tend to pivot downward by the gravity force. For example, if the operation lever 563 pivots rightward in the loosening operation so as to be oriented vertically downward when the horizontal rod 561 is positioned at the upper end of the guide slot 523 of the angular plate 52 as shown in FIG. 12, it may be possible that the end portion of the operation lever 563 contacts the upper surface of the base 13 in a manner like a strut when the saw body 20 pivots rightward from the leftward pivoted position shown in FIG. 12 toward the vertical position. Thus, the saw body 20 may be prevented from returning to the vertical direction. However, in this embodiment, a rib 522 may be formed to protrude horizontally from the front surface of the angular plate 52. The rib 522 may have an arc shape portion and a linear portion. The arc shape portion may extend along the lower side of the guide slot 523. The linear portion may extend horizontally along the upper surface of the base 13. Therefore, during the movement of the saw body 20 from the leftward inclined position to the vertical position, the lower end of the operation lever 563 positioned at the loosening position and extending downward by the gravity force may contact the rib 522, so that the operation lever 563 may be kept to be always inclined relative to the base 13. In this way, the operation lever 563 may not prevent the saw body 20 from moving from the leftward pivoted position to the vertical position.

A scale plate 525 may be attached to the outer circumferential surface of the angular plate 52 and may have a scale indicating inclination angles with respect to the left and right directions of the saw body 20 relative to the base 13. In this connection, as shown in FIG. 13, an arrow mark 54y may be marked on the end portion of the angular guide 54 for pointing any of scale lines of the scale corresponding to various inclination positions of the saw body 20. As shown in FIG. 13, the scale plate 525 may be fitted into a scale plate accommodation groove 527 formed in the outer circumferential surface of the angular plate 52. As shown in FIGS. 11 and 12, fastening screws 528 may be threadably engaged with corresponding threaded holes formed in the front surface of the angular plate 52 and may extend into the scale plate accommodation groove 527. Therefore, the end portions of the fastening screws 528 may contact the upper and lower end portions of the scale plate 525 for pressing the scale plate 525 against one of opposite side walls of the scale plate accommodation groove 527. In this way, the scale plate 525 can be fixed in position relative to the angular plate 52. Each of the scale plate 525 and the scale plate accommodation groove 527 may be formed to have a shape extending along an arc that is coaxial with the are shape of the guide slot 523. In addition, the scale plate accommodation groove 527 may be configured to allow relative movement of the scale plate 525 within a predetermined range, such as a range of within 0.5 mm, in the circumferential direction. Therefore, it may be possible to perform a fine adjustment of the position of the scale plate 525 in the circumferential direction relative to the angular plate 52. For example, the vertical position of the saw body 20 relative to the base 13 may be set by the adjustment of the angle adjusting screw 13x of the base 13. In this state, the position of the scale plate 525 may be adjusted such that the arrow mark 54y of the angular plate 54 points a 90 degree line of the scale lines of the scale of the scale plate 525. After that, the position of the scale plate 525 relative to the scale plate accommodation grove 527 may be fixed by the fastening screws 528. In this way, it may be possible to adjust the position of the scale plate 525 such that the inclination angle can be correctly pointed by the arrow mark 54y.

### <Operations and Advantages of Circular Saw>

Before using the circular saw 10, the user can adjust the inclination angle of the saw blade 21 of the saw body 20 relative to the base 13 with respect to the right and left directions by the operation of the inclination adjusting mechanism 50 according to the intended use of the circular saw 10. Thus, the user may operate the operation lever 563 of the inclination lock mechanism 56 for releasing the lock state of the saw body 20 with respect to the movement in the right and left directions. After that, the user may adjust the inclination angle of the saw body 20 by pivoting the saw body 20, so that the angular guide 54 may pivot in the right and left directions relative to the angular plate 52 as shown in FIGS. 11 and 12. When the inclination angle has been adjusted with reference to the scale line of the scale of the scale plate 525 of the angular plate 52 pointed by arrow mark 54y of the angular guide 54, the user may operate the operation lever 563 to lock the position of the saw body 20 with respect to the right and left directions. In this way, the operation for adjusting the inclination angle of the saw body 20 with respect to the right and left directions can be completed.

In addition, before using the circular saw 10, the user can also adjust the protruding distance of the saw blade 21 from the lower surface of the base 13 by the cutting depth adjustment mechanism 40 according to the intended use. Thus, the user may operate the operation lever 45y of the guide lock mechanism 45 of the cutting depth adjustment mechanism 40 (see FIG. 1) for releasing the lock state of the saw body 20 with respect to the vertical direction. After that, the user may pivot the saw body 20 vertically about the axis of the connection bolt 41 to move the horizontal rod 451 of the saw body 20 along the guide plate portion 43g (more specifically, the guide slot 43z) of the depth guide 43. When the protruding distance of the saw blade 21 from the lower surface of the base 13 has been adjusted with reference to the scale that indicates the cutting depth and marked on the guide plate portion 43g, the user may operate the operation lever 45y of the guide lock mechanism 45 to lock the position of the saw body 20 with respect to the vertical direction. In this way, the operation for adjusting the protruding distance of the saw blade 21 from the lower surface of the base 13 can be completed.

Further, before using the circular saw 10, the user may pivot the hook body 31 of the hook 30 rightward by an angle of about 90 degrees from the operational position to the rest position, so that the intermediate portion 33 of the hook body 31 can be accommodated in the accommodation recess 231h formed in the boundary region between the front grip portion 231f and the upwardly extending portion 231 of the handle 230. Therefore, the hook 30 may not interfere with the operation of the circular saw 10 during the cutting operation of the workpiece W.

Thus, the user may hold the rear grip portion 233 of the handle 230 with his or her dominant hand and may pull the trigger switch 232 with the finger(s) of the hand grasping the rear grip portion 233, so that the motor 20 may be started to rotate the saw blade 21. Then, the user may place the circular saw 10 on the workpiece W such that the lower surface of the base 13 contacts the upper surface of workpiece W. After that, the user may move the circular saw 10 forwardly along the upper surface of the workpiece W, so that a lower portion of the saw blade 12 protruding downward from the base 13 may cut the workpiece W. During the cutting operation, cutting chips or powder may rise upward from the workpiece W. However, because the shield portion 240 protrudes in right and left directions from the base portion 234 of the handle 230, cutting chips or powder may be prevented from rising upward toward the user. In addition, because the display portion 244x may be disposed at the upper surface of the shield portion 240, it may be possible to avoid the cutting chips or powder from deposition on the display portion 244. Therefore, the user can view the display portion 244x without being prevented from viewing by the cutting chips or powder. Further, because the external air introduced by the fan 20mf of the motor 20m may flow though the space within the shield portion 240, it may be possible to efficiently cool the controller 242 disposed within the space.

Furthermore, according to the above embodiment, the fixed cover 24 is fixed to the gear housing 22 that serves as an accommodation portion for accommodating the reduction mechanism 20g that rotatably drives the saw blade 21. The hook 31 may be disposed at the axially inner vertical wall 24t of the fixed wall 24 extending in a direction substantially perpendicular to the axial direction of the spindle 20s of the reduction mechanism 20g. With this arrangement, the hook 30 may be positioned to be nearer to the gravity center of the circular saw 10. For this reason, when the hook 30 of the circular saw 10 is hooked over a support structure, the portable circular saw 10 can be suspended in a stable manner from the support structure.

Further, according to the above embodiment, the hook body 31 has a substantially U-shape. The first side portion 32 of the book body 31 is attached to the axially inner vertical wall 24t of the fixed cover 24 such that it extends substantially parallel to the axially inner vertical wall 24t. Therefore, the weight of the circular saw 10 can be efficiently supported by the hook 30.

Furthermore, according to the above embodiment, the fixed cover 24 is made of metal and integrally molded with the gear housing 22. Therefore, it may be possible to increase the strength of a portion to which the hook 30 is attached.

Furthermore, according to the above embodiment, the hook 30 is positioned on the front side of the rotational axis of the saw blade 21. Therefore, when the circular saw 10 is supported by a support structure so as to be suspended therefrom by hooking the hook 30 over the support structure, the front side of the circular saw 10 may be oriented on the upper side. Therefore, it may be possible to easily perform the operation for unhooking the hook 30 from the support structure and carrying the circular saw 10 to a work site, etc.

Furthermore, according to the above embodiment, the hook 30 is attached to the axially inner vertical wall 24t of the fixed cover 24 such that it can pivot relative to the axially inner vertical wall 24t about the axis of the first side portion 32 that extends upward so as to be inclined obliquely rearward along the outer surface of the axially inner vertical wall 24t. Therefore, it may be possible to minimize the protruding distance of the hook 30 from the outer surface of the fixed cover 24. As a result, it may be possible to avoid potential interference of the hook 30 with the other components of the circular saw 10.

### Second Embodiment

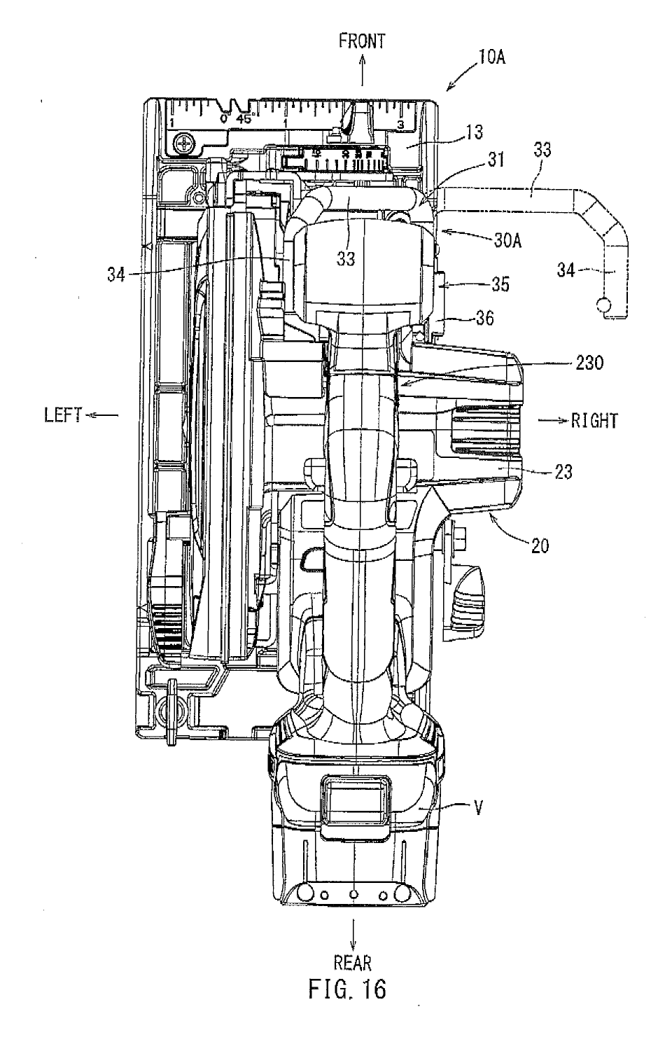

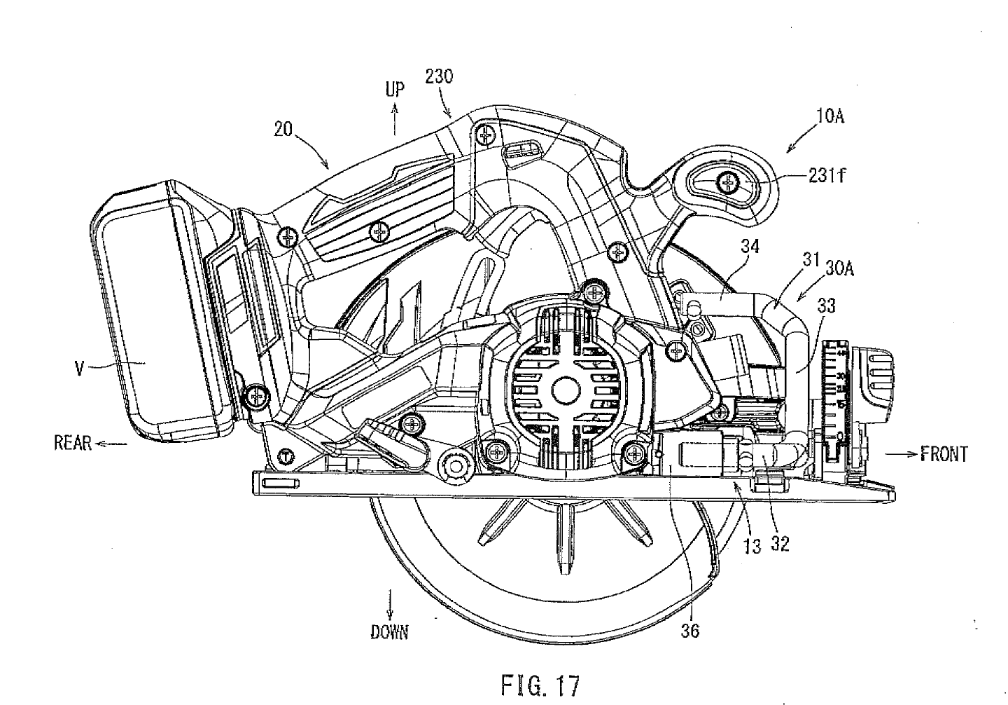

The above embodiment may be modified in various ways. FIG. 16 and FIG. 17 show a circular saw 10A having a hook 30A according to a second embodiment. This embodiment is a modification of the first embodiment. Therefore, in FIGS. 16 and 17, like members are given the same reference numerals as the first embodiment and the description of these members will not be repeated. In the first embodiment, the hook 30 (or the support tube 36 of the bracket 35 supporting the hook 30) is attached to the inner axially vertical wall 24t of the fixed cover 24. However, in the circular saw 10A according to the second embodiment, the bracket 35 may be mounted to the front portion of the base 13 such that the support tube 36 extends along the right side edge of the base 13. In this embodiment, the first side portion 32 of the book body 31 of the hook 30A may be inserted into the support tube 36 from its front side. With this arrangement, the hook 30A may be pivoted leftward about the axis of the first side portion 32 from a rest position indicted by solid lines to an operational position indicated by chain lines in FIGS. 16 and 17. In the operational position, the intermediate portion 33 may extend rightward from the right side edge of the base 13, while the hook body 31 may extend within a plane substantially parallel to the upper surface of the base 13. In the rest position, the hook body 31 may be located on the lower side of the front grip portion 231f. Therefore, the hook body 31 may not interfere with the operation of the circular saw 10A.

### Third Embodiment

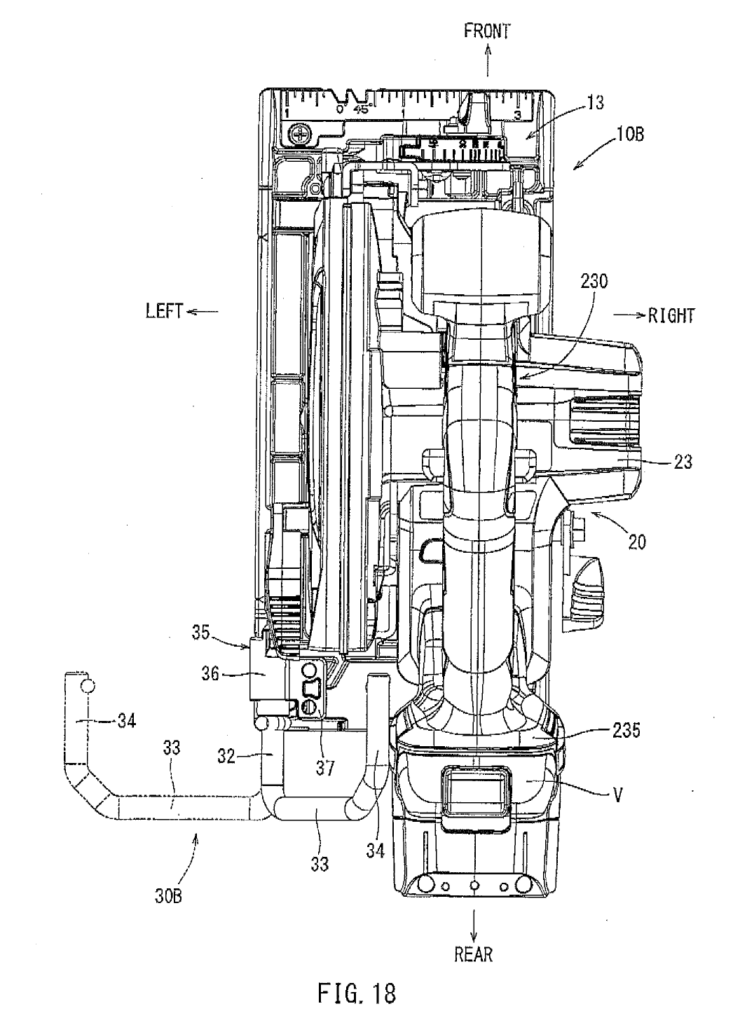

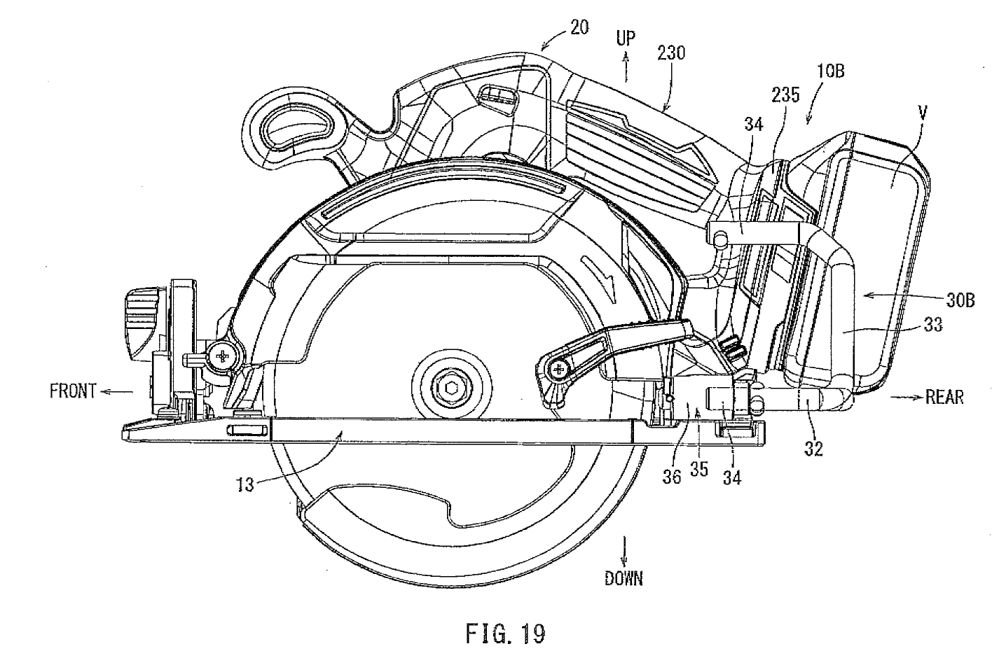

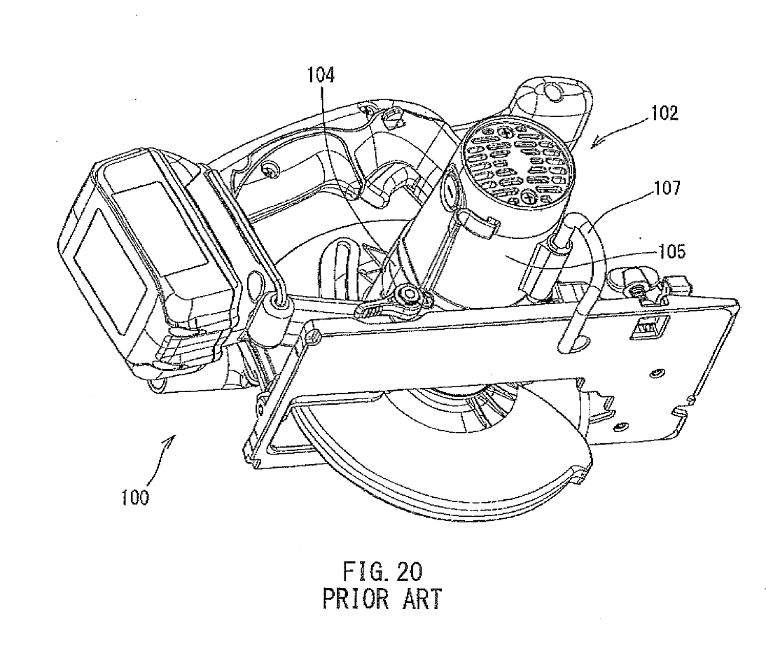

FIG. 18 and FIG. 19 show a circular saw 10B having a hook 30B according to a third embodiment. Also, this embodiment is a modification of the first embodiment. Therefore, in FIGS. 18 and 19, like members are given the same reference numerals as the first embodiment and the description of these members will not be repeated. In the circular saw 10B according to the third embodiment, the bracket 35 may be mounted to the rear portion of the base 13 such that the support tube 36 extends along the left side edge of the base 13. In this embodiment, the first side portion 32 of the hook body 31 of the hook 30B may be inserted into the support tube 36 from its rear side. With this arrangement, the hook 30B may be pivoted leftward about the axis of the first side portion 32 from a rest position indicted by solid lines to an operational position indicated by chain lines in FIGS. 18 and 19. In the operational position, the intermediate portion 33 may extend leftward from the left side edge of the base 13, while the hook body 31 may extend within a plane substantially parallel to the upper surface of the base 13. In the rest position, the intermediate portion 33 and the second side portion 34 may be located proximal to the left side of the connection portion 235 to which the battery V is connected. Therefore, also in this embodiment, the hook body 31 may not interfere with the operation of the circular saw 10B.

### [Other Possible Modifications]

Although the above embodiments have been described in connection with circular saws 10, 10A and 10B, the above teaching may be applied to any other portable cutting devices, such as a router and a trimmer.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved portable cutting devices, and methods of making and using the same.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A portable cutting device comprising:
a device body comprising a rotary cutter, a motor, a reduction mechanism coupled to the motor and configured to rotate the rotary cutter, an accommodation portion configured to accommodate the reduction mechanism, and a fixed cover configured to cover the rotary cutter;
wherein the reduction mechanism includes an output shaft extending in a first direction; and
wherein the fixed cover includes a wall portion extending in a second direction that is not parallel to the first direction;
a base having an upper surface and a lower surface and configured to support the device body on an upper side of the upper surface, the lower surface being configured to contact a surface of a workpiece to be cut; and
a hook attached to the wall portion of the fixed cover.

2. The portable cutting device according to claim 1, wherein:
the hook has a hook body including a first side portion, a second side portion opposite to the first side portion, and an intermediate portion connecting the first side portion and the second side portion, so that the hook body has a substantially U-shape;
the first side portion is attached to the wall portion so as to extend substantially parallel to the wall portion.

3. The portable cutting device according to claim 1, wherein the wall portion is made of metal.

4. The portable cutting device according to claim 1, wherein the wall portion of the fixed cover and the accommodation portion for the reduction mechanism are formed integrally with each other.

5. The portable cutting device according to claim 1, the hook is attached to the wall portion of the fixed cover at a position forwardly of a rotational axis of the rotary cutter with respect to a moving direction of the portable cutting device for cutting the workpiece.

6. The portable cutting device according to claim 2, wherein the first side portion of the hook body has an axis and is attached to the wall portion so as to be rotatable about the axis.

7. The portable cutting device according to claim 2, wherein:
the first side portion of the hook body extends in an axial direction along the wall portion of the fixed cover; and
the axial direction is oriented upward and inclined rearward with respect to a moving direction of the portable cutting device for cutting the workpiece, so that the first side portion extends along the wall portion of the fixed cover.

8. The portable cutting device according to claim 6, wherein:
the hook body is pivotable between an operational position and a rest position about the axis of the first side portion;
the device body further includes a handle and a grip portion disposed at the handle; and
as the hook body pivots from the operational position to the rest position, the hook body passes over the handle, so that the book body is not positioned above the grip portion when at the rest position.

9. The portable cutting device according to claim 8, wherein the handle includes an accommodation recess configured to accommodate at least a part of the intermediate portion of the hook body when the hook body is positioned at the rest position.

10. The portable cutting device according to claim 1, wherein the fixed cover includes an axially inner wall disposed on a side of the accommodation portion, an axially outer wall opposite to the axially inner wall, and a circumferential wall connecting the axially inner wall and the axially outer wall, wherein the wall portion is a part of the axially inner wall.

11. A portable cutting device comprising:
a device body comprising a rotary cutter, a motor configured to rotate the rotary cutter about a rotational axis, and a fixed cover configured to cover the rotary cutter;
a base having an upper surface and a lower surface and configured to support the device body on an upper side of the upper surface, the lower surface being configured to contact a surface of a workplace to be cut;
a hook having a hook body attached to at least one of the device body and the base so as to be pivotable relative thereto between an operational position and a rest position about a pivotal axis extending in a direction that is not parallel to the rotational axis of the rotary cutter.

12. The portable cutting device according to claim 11, wherein:
the fixed cover includes an axially inner wall disposed on a side of the motor, an axially outer wall opposite to the axially inner wall, and a circumferential wall connecting the axially inner wall and the axially outer wall,
the hook body is attached to the axially inner wall of the fixed cover.

13. The portable cutting device according to claim 12, wherein:
the pivotal axis of the hook body extends substantially parallel to the axially inner wall of the fixed cover.

14. The portable cutting device according to claim 12, wherein:
the pivotal axis of the hook body extends upward while being inclined rearward with respect to a moving direction of the portable cutting device for cutting the workpiece.

15. The portable cutting device according to claim 12, wherein:
the book body includes a first side portion, a second side portion opposite to the first side portion, and an intermediate portion connecting the first side portion and the second side portion, so that the hook body has a substantially U-shape;
the first side portion is attached to the axially inner wall of the fixed cover so as to be pivotable about the pivotal axis, while the second side portion being configured as a free end portion;
when the hook body is positioned at the operational position, the second side portion extends forwardly relative to the first side portion with respect to a moving direction of the portable cutting device for cutting the workpiece.

16. The portable cutting device according to claim 11, wherein:
the hook body is attached to the upper surface of the base;
the upper surface of the base includes a front portion, a rear portion, a right portion and a left portion with respect to a moving direction of the portable cutting device for cutting the workpiece.

17. The portable cutting device according to claim 16, wherein:
the hook body includes a first side portion, a second side portion opposite to the first side portion, and an intermediate portion connecting the first side portion and the second side portion, so that the hook body has a substantially U-shape;

18. The portable cutting device according to claim 17, wherein:
the first side portion of the hook body is attached to the front portion of the upper surface of the base, while the second side portion being configured as a free end portion; and
when the hook body is positioned at the operational position, the second side portion extends rightward from a right side edge of the right portion of the base.

19. The portable cutting device according to claim 17, wherein:
the first side portion of the hook body is attached to the rear portion of the upper surface of the base, while the second side portion being configured as a free end portion; and
when the hook body is positioned at the operational position, the second side portion extends leftward from a left side edge of the left portion of the base.
